(19) United States
(12) Patent Application Publication
(10) Pub. No.: US 2023/0010701 A1
(43) Pub. Date: Jan. 12, 2023

(54) MULTI-PURPOSE APPARATUS AND METHOD FOR PREVENTIVE LIGHT SIGNALLING OF THE PROGRESS OF A VEHICLE

(71) Applicant: Mohamed Ait El Hadj, Nice (FR)

(72) Inventor: Mohamed Ait El Hadj, Nice (FR)

(21) Appl. No.: 17/780,698

(22) PCT Filed: Nov. 19, 2020
(86) PCT No.: PCT/EP2020/082664

§ 371 Date: May 27, 2022

(30) Foreign Application Priority Data
Dec. 10, 2019 (FR) FR1914093

(51) Int. Cl. G08B 5/00; B60Q 1/26; B62J 6/015; B62J 6/057; B62J 6/045

(52) U.S. Cl. CPC G08B 5/006; B60Q 1/2607; B62J 6/015; B62J 6/057; B62J 6/045; B60Q 2900/50; B60Q 2900/30

(57) ABSTRACT

The apparatus comprises two identical control devices (11a, 11b) which generate activation commands (24a, 24b) for preventive lights (2a-2e) signalling the progress of a vehicle (1). Each of the control devices (11a, 11b) is provided with driver-operated inhibiting members (17a, 17b, 18) for inhibiting the generation of at least one of said activation commands (24a, 24b) which is to be inhibited. The control devices (11a, 11b) can be used in a complementary fashion from an activation or deactivation of the inhibiting members (17a, 17b, 18) which they respectively include, by distribution between the control devices (11a, 11b) of the activation commands (24a, 24b) which they respectively emit to activate preventive lights (2a-2e) which include at least one piece of preventive equipment (4).

### TECHNICAL FIELD OF THE INVENTION

The invention relates to the field of light signalling of the progress of a vehicle. More particularly, the invention relates to methods for implementing visible light signalling of the progress of a vehicle, in the event of a temporary or permanent deficiency in a satisfactory visibility of the progress of the vehicle by the other users of the traffic lanes.

More specifically, the invention relates to an apparatus for light signalling of the progress of a vehicle and its operating methods, according to which preventive signalling lights are selectively activated by activation commands which are generated by an emitter under the control of a driver of the vehicle, and which are transmitted remotely by the emitter in the form of radio-frequency signals to a receiver for activating the preventive lights.

### PRIOR ART

Land vehicles are commonly equipped with signal lights, hereinafter referred to as main lights, enabling the driver of a vehicle to indicate to the other users of the traffic lanes the presence, changes in the direction and/or braking of the vehicle. The main lights commonly comprise position lights and/or optionally fog lights allowing signalling the presence of the vehicle, right and left indicators to signal a change in the direction of the vehicle, brake lights to signal braking or stopping of the vehicle, and optionally hazard lights by simultaneous activation of the indicators signalling a vehicle in difficulty and/or a danger. In particular, such main lights are installed on the frame and/or on the bodywork of the vehicle, and are supplied with electricity from an electrical circuit on board the vehicle, while being able to be selectively activated by the driver from the driving position of the vehicle.

However, among vehicles, some do not have a passenger compartment, such as motorised or non-motorised cycles. In the absence of a passenger compartment, the possibilities of visible installation of main lights on the vehicle are restricted, to the detriment of their visibility by the other users of the traffic lanes. It is common for non-motorised cycles to be devoid of main lights and for motorised cycles to be equipped with main lights that are too close to the ground to facilitate their visibility by the other users of the traffic lanes.

This is why apparatuses have been proposed providing visible light signalling of the progress of motorised or non-motorised cycles, as comes out for example from the documents FR 2 870 505 (AIT EL HADJ MOHAMED) and FR 3 003 214 (AIT EL HADJ MOHAMED).

In general, such an apparatus comprises a support for carrying signal lights, hereinafter referred to as preventive lights. The support is arranged as a harness which is visibly carried by an individual installed on the cycle, either the driver or a rear passenger of the cycle, in particular in the dorsal position of the individual to make the preventive lights visible from the rear of the cycle by the other users of the traffic lanes. The apparatus also comprises a case housing an emitter which generates commands for the selective activations of preventive lights, under the control of the driver of the cycle. Said activation commands are transmitted remotely by the emitter to a receiver, in particular by radio-frequency, the receiver being installed on the support and activating the preventive lights in accordance with the activation commands which it receives from the emitter.

More particularly, according to the document FR 2 870 505, the apparatus is organised so as to be used in the context of a motorised cycle equipped with main lights. The on-board electrical circuit equipping the motorised cycle for the activation of the main lights, is used to activate the preventive lights synchronously with the main lights, through the cooperation between the receiver and the emitter which is connected to the on-board electrical circuit of the motorised cycle.

More particularly, still according to the document FR 3 003 214, the apparatus is organised so as to be used in the context of a cycle devoid of main lights or only equipped with a main brake light. The driver of the cycle has a control device installed on the handlebar of the cycle, the control device comprising a case provided with control members and housing the emitter. The driver controls the emitter via the control members, to generate said activation commands which are then transmitted remotely by radio-frequency to the receiver by the emitter to activate the preventive lights.

It could be noticed that such apparatuses and/or the methods of implementation thereof deserve to be improved, to best address the needs of drivers likely to use them. Indeed, such apparatuses are organised so as to be used according to the type of vehicle whose progress is to be signalled. This has the consequence of having to develop and produce such apparatuses which are diversified to address the specific needs of the particular cases of vehicles whose progress is to be signalled.

### Presentation of the Invention

In this context, an object of the present invention is a preventive apparatus for light signalling of the progress of a vehicle, and methods for implementation thereof, comprising preventive lights which are installed on a support intended to be visible to the other users of the traffic lanes.

Based on the observation that has just been made, the invention aims to provide such an apparatus which is versatile, by being adapted to be used to address all or part of the various needs for preventive light signalling of the progress of a vehicle.

A related objective is to provide such a device, the configuration and operating methods of which enable its use for various vehicles, in particular with regards to whether or not a vehicle is equipped with main lights, and/or with regards to the methods for controlling the operation of the apparatus by the driver of a vehicle.

Another related objective is to optimise the preventive light signalling of the progress of the vehicle, by limiting the effects induced on the ease of use of the apparatus by a user.

Another related objective is to reduce the production costs of such an apparatus, by providing such an apparatus whose organisation allows addressing at lower cost specific needs relating to the preventive light signalling of various types of vehicles.

For this purpose, an apparatus in accordance with the invention is a preventive apparatus for activating preventive lights at least during the progress of a vehicle. The apparatus comprises at least:
preventive light signalling equipment, including a support on which is installed a preventive light signalling device. Said preventive device at least comprises a receiver by radiofrequency of commands for selective activations of preventive lights, said preventive lights and an electrical energy reserve for supplying at least the receiver with electricity.
a control device via which said activation commands are generated. The control device includes a case housing an emitter which generates said activation commands under the control of a driver of the vehicle and which emits by radiofrequency the activation commands generated by the emitter.

On this basis and essentially, the aims targeted by the invention are achieved, separately or in combination, by providing such an apparatus comprising several control devices which are adapted to cooperate together by complementarity of generation and emission of the activation commands of the preventive lights that are respectively assigned thereto.

The apparatus is organised into a modular apparatus comprising control devices which are identical, and each of which is equipped with members inhibiting the generation and the emission of commands for the activation of preventive lights which are generated and emitted by at least one other control device. Continuing in this approach, a choice of distribution is also proposed between two said control devices for the generation and the emission of commands for the activation of preventive lights which are respectively assigned thereto, according to which:
one of the control devices is a generator and emitter of commands for the activation of preventive lights whose activation is permanent over a long period, such as preventive position lights, a preventive fog light and a preventive hazard light, and
the other one of the control devices is a generator and emitter of commands for the activation of preventive lights, the activation of which is brief and repeated, potentially at sustained frequencies, such as preventive right and left indicator lights and a preventative brake light.

Thus, in general, a preventive apparatus in accordance with the invention comprises at least two said control devices which are identical. Each of the control devices is equipped with:
a rechargeable battery for supplying the emitter with energy,
a first socket for connecting the battery to an electric power supply source for charging thereof,
a second socket for connecting the emitter to an activation circuit of main lights equipping a vehicle, and
members for controlling a selective generation by the emitter of said activation commands, said control members could be actuated by an individual, in particular the driver of the vehicle.

Furthermore, each of the control devices is equipped with at least one so-called inhibitor member, which could be actuated by an individual to inhibit the generation by the emitter of at least one of said activation commands, then so-called activation command to be prohibited.

The apparatus is organised as a modular apparatus comprising several modules divided into several categories.

A first category of preventive modules comprises one or several light signalling module(s) each of which is formed by said preventive equipment. The preventive modules may be arranged in a various way according to different types of vehicle and/or according to the applications or uses of the apparatus for the same vehicle type, in particular with regards, on the one hand, to the arrangement of the support and, on the other hand, to the number and/or the arrangement on the support of the preventive lights with which they are equipped.

A second category of control modules comprises at least two identical control modules each of which is formed by one of the control devices. The control modules may be used separately or in cooperation with each other based on the inhibition, via said at least one inhibitor member, of the generation by the emitter of at least any one of the control devices of one or several activation command(s).

The modular organisation of the apparatus enables use thereof at least in accordance with a method according to which the preventive lights of at least one piece of preventive equipment are activated by at least one of the control devices. Depending on the type of vehicle varying according to whether or not the vehicle is equipped with main lights,
either the control devices are used in complementarity upon an activation or a deactivation of said at least one inhibitor member that they respectively include, by distribution between the control devices of the activation commands that they respectively emit for the activation of preventive lights that at least one preventive equipment includes,
or any one of the control devices is used separately under the control of the driver of the vehicle for the activation of the preventive lights.

According to a particular implementation of such a method applied for a vehicle equipped with main lights, two control devices are used in complementarity and comprise a first control device and a second control device. The control members of the first control device could be actuated by the driver of the vehicle. The generation by the emitter of commands for individual activations at least of a preventive right indicator light, of a preventive left indicator light, and also preferably of a preventive brake light, is deactivated via said at least one inhibitor member that the first control device includes.

It should be noted that the preventive right and left indicator lights and the preventive brake light are light signalling lights whose respective activations have a short activation period and potentially activated at sustained frequencies.

The second control device is installed on the vehicle, the emitter included therein being connected via said second socket to a multi-strand cable plugging the emitter to the electric power supply circuit equipping the vehicle and assigned to the selective activation of the main lights of the vehicle. The emitter of the second control device generates commands for individual activations of preventive lights comprising a preventive right indicator light, a preventive left indicator light and a preventive brake light. A generation by the second emitter of activation commands for any other preventive lights that said at least one piece of preventive equipment includes being deactivated via said at least one inhibitor member that the second control device includes.

Preferably, the emitter of the second control device is supplied with electrical energy from strands that said multi-strand cable includes and which are connected to the wires of the electric power supply circuit assigned to the activation of a main position light of the vehicle.

The electrical connection between the emitter and the rechargeable battery is then deactivated, preferably spontaneously upon detection by the electrical circuit of the emitter of its connection to said electric power supply circuit.

It should be noted that said other preventive lights for which the generation by the emitter of the second control device is deactivated, are in particular light signalling lights whose respective activations have a long duration. These comprise in particular a preventive fog light, a preventive hazard light and a preventive position light, the activation of the position light by the second control device being inhibited by the connection of the emitter of the second control device to said electric power supply circuit of the main lights of the vehicle.

Such a choice of the distribution of the respective activations of the preventive lights by the first control device and the second control device, allows relieving the driver from having to permanently manipulate the first control device to individually activate the preventive right and left indicator lights and the preventive brake light, and/or having to install the first control device on the steering member of the vehicle. Indeed, with regards to the group of preventive lights with a long activation period, which are permanently selectively activated to signal its presence and/or position from the rear of the vehicle, in particular in the event of danger or in the event of fog, the first control device could be turned on when needed and be stowed pending its use, for example in a pocket of a garment of the driver or on board the vehicle, such as under the seat of a motorcycle.

More specifically and for example,
the generation by the emitter of the first control device of commands for individual activations of a preventive right indicator light, of a preventive left indicator light and of a preventive brake light are deactivated, via an inhibitor contactor which is preferably actuated by a foolproof equipping each of the control devices as mentioned hereinafter with regards to a preferred embodiment of the apparatus.
the generation by the emitter of the second control device of commands for activations of any preventive lights other than the preventive right indicator light, the preventive left indicator light and the preventive brake light, are deactivated via the control members equipping the second control device.

According to an embodiment of the apparatus, said at least one inhibitor member is formed by at least one inhibitor contactor. Advantageously, the inhibitor contactor is dedicated to the inhibition of a generation by the emitter of at least one activation command to be prohibited, in particular activation commands to be prohibited comprising a command for the activation of the preventive right and left lights and of a preventive stop light.

More specifically, the inhibitor contactor is preferably monostable and advantageously could be selectively actuated by a foolproof between two distinct positions of installation of said case on a base for mounting the control device on the vehicle.

For example, the inhibition of the generation by the emitter of said at least one of the activation commands to be prohibited being spontaneously effective in a stable position of the inhibitor contactor and conversely, the generation by the emitter of said at least one of the activation commands to be prohibited being effective by actuation of the inhibitor contactor by the foolproof.

According to an embodiment of the apparatus, said at least one inhibitor member is formed by at least one of the control members.

In particular, each of the control members equipping the control devices is arranged as an impulse pushbutton which is mounted on the case of the control devices. Depending on the number and/or the duration of pulse(s) exerted on the pushbuttons, these could be used to activate or deactivate the generation of said activation commands by the emitter.

According to one embodiment, said at least one inhibitor member is a member for inhibiting a generation of activation commands of preventive lights with a long activation period, of the type of preventive lights at least comprising a preventive hazard light, a preventive fog light and a preventive position light.

According to one embodiment, said at least one inhibitor member is a member for inhibiting a generation of activation commands of preventive lights with a short activation period, of the type of preventive lights at least comprising a preventive right indicator light, a preventive left indicator light and a preventive brake light.

According to one embodiment, a first support is arranged as a harness for carrying preventive equipment in the dorsal position of an individual.

According to one embodiment, a second support is a translucent box which houses the preventive lights visible from at least one external face of the box and which is provided with members for reversibly fastening preventive equipment in the rear position on the vehicle.

For example, such a box may be installed on a rear luggage rack of a vehicle potentially devoid of main lights temporarily or permanently, a cycle or motorcycle for example. Where necessary, such as for a motorcycle for example, the box may be installed as an extension of the main lights equipping the vehicle to compensate for unsatisfactory visibility of the progress of the vehicle in the case where the main lights lie too close to the ground. For example, such a box may be installed at the rear of a transport accessory mounted at the rear of a vehicle, such as an accessory for transporting cycles or luggage. Such a box may also be used for vehicles or trailers for which the installation of signalling lights is temporarily desired, in particular in order to preserve them when the vehicle evolves in a hostile environment, such as for an agricultural machine or a construction machine.

The possibility of using several control devices in complementarity not only allows limiting the task of a driver to selectively activate the preventive lights of at least one preventive equipment, but also optimizing the number of preventive lights with which said at least one preventive equipment is provided. Preventive lights could be used to signal the progress of a vehicle, including in the case where the vehicle is not or unusually equipped with some main signalling lights.

This is why an embodiment of the device is advantageously provided, according to which the preventive lights that at least one said preventive equipment of the device includes, comprise at least:
a preventive right indicator light and a preventive left indicator light,
a preventive brake light,
a preventive hazard light, such as by simultaneous, or in other words joint, activation of the preventive right indicator light and the preventive left indicator light. The commands for the individual activations of the preventive right indicator light and of the preventive left indicator light are distinct from a command for the activation of the preventive hazard warning light causing their simultaneous activation.
a preventive position light,
a preventive fog light.

As non-exhaustive examples of the diversity of types of vehicle to which the invention could be applied, mention may be made of a vehicle equipped with main lights whose number and/or functions could be diversified, a vehicle devoid of main lights, a vehicle devoid of main lights and provided with a steering member, a vehicle devoid of main lights and devoid of a steering member, or for example a utility vehicle equipped with main lights removably installed on a vehicle to enable removal thereof.

As regards a vehicle equipped with main lights whose number and/or functions may be various, such as a motorcycle, a unique control device may be used or two control devices may be used in complementarity. Indeed, a motorcycle is equipped at the rear with main right and left indicator lights, a main brake light and a main position light, is optionally equipped with a main hazard light and is commonly devoid of a main fog light.

In this case, a unique control device may be used by being connected via the second socket by a multi-strand cable to an electric power supply circuit of main lights. However, such a solution does not allow, or hardly allows, operating all of the preventive lights of the apparatus. Furthermore, the installation of a control device on the handlebar of a motorcycle is cumbersome and inconvenient for the driver.

To overcome this problem, two control devices may be used according to any equipment of the vehicle as main lights. A first control device may be supplied with electricity from the rechargeable battery that it comprises and be controlled by an individual, for example, but not exclusively, by the driver. A second control device may be connected to the electric power supply circuit of the main lights of the vehicle.

Upon the activation of said at least one inhibitor member equipping the control devices, the second control device may be assigned to the control of the activation of preventive lights with brief and repeated activations at substantially sustained frequencies, such as in particular preventive right and left indicator lights and a preventive brake light, and the first control device may be assigned to the control of the activation of preventive lights with lasting activations, such as in particular a preventive position light, a preventive fog light or a preventive hazard light.

As regards a vehicle devoid of main lights, such as a bicycle, a motorised or non-motorised scooter, a skateboard, a hoverboard or a Segway, a unique control device may be used by the driver of the vehicle.

More particularly, as regards a vehicle devoid of main lights and provided with a steering member, such as a bicycle, a motorised or non-motorised scooter or a Segway, the control device may be installed on the steering member, via a base for receiving the case of the control member. The support of the preventive equipment may be formed by a back harness, optionally equipped with other preventive equipment removably installed in a position covering the torso visible from the front of the driver.

More particularly, as regards a vehicle devoid of main lights and devoid of a steering member, such as a skateboard or a gyroscopic board, the control device could be manipulated by the driver by holding the case, or by installing the control device on a base arranged as an armband.

As regards a utility vehicle equipped with main lights removably installed on a vehicle, such as a trailer, an agricultural machine and/or a construction machine, such utility vehicles could alternatively progress on a traffic lane frequented by other users or outside such traffic lanes in a potentially hostile environment likely to degrade the main lights with which they are equipped, such as by projection of particles such as gravel or pebbles or by obstacles to the progress of the vehicle which might prove to be difficult.

In this case, the main lights could be removed for protection thereof. To avoid repeated operations of installation and/or removal of the main lights, the light signalling of such a vehicle progressing on a traffic lane may be obtained by means of one or several preventive equipment, the activation of the preventive lights may be performed by means of any one of the control devices or of several control devices which are then complementary by exclusive distribution therebetween of the commands for the activation of preventive lights that are respectively assigned thereto.

### PRESENTATION OF THE FIGURES

The invention will be better understood upon reading the following detailed description of embodiments of components of an apparatus and the implementation thereof in accordance with the invention, with reference to the following figures:

FIG. 1 is an exploded top perspective illustration of an embodiment of a control device that an apparatus in accordance with the invention comprises. In FIG. 1, the control device is represented in the installation position on a base configured to be mounted on the handlebar of a cycle.

FIG. 2 is an assembled top perspective illustration of the control device represented in FIG. 1. In FIG. 2, the control device is represented installed on the base.

FIG. 3 is a perspective bottom illustration of an embodiment of an emitter that the control device represented in FIG. 1 and FIG. 2 comprises.

FIG. 4 is an exploded rear perspective illustration of an embodiment of preventive equipment that an apparatus in accordance with the invention comprises. In FIG. 4, the preventive equipment includes a preventive light signalling device represented in the installation position on a support that the equipment includes and which is arranged as a back harness.

FIG. 5 is a rear illustration of an embodiment of the preventive light signalling device that the preventive equipment represented in FIG. 4 comprises and which is installed on the support.

FIG. 6 is a diagram illustrating an embodiment of an implementation of an apparatus in accordance with the invention.

### DETAILED DESCRIPTION OF THE INVENTION

The figures and their non-limiting detailed descriptions set out the invention in particular terms which are not restrictive as to the scope of the invention. The figures and their detailed descriptions of embodiments of the invention could be used to better define it, where necessary with regards to the general description that has just been given. Moreover, to avoid overloading the figures and thus facilitate reading thereof, the reference numerals assigned to the terms and/or concepts used to describe the invention and indicated in any of the figures are potentially included in the description of any other figure without implying their presence in all figures.

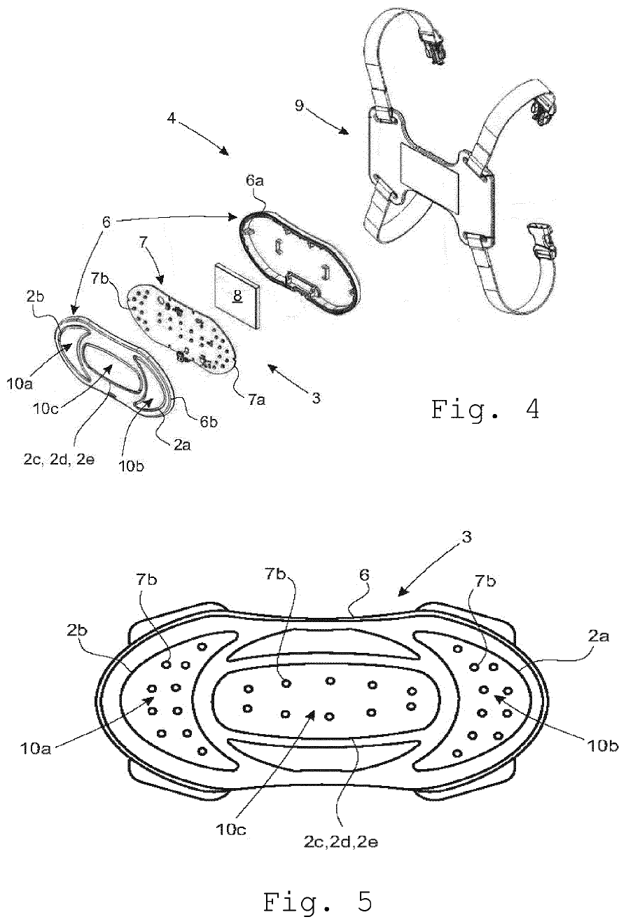

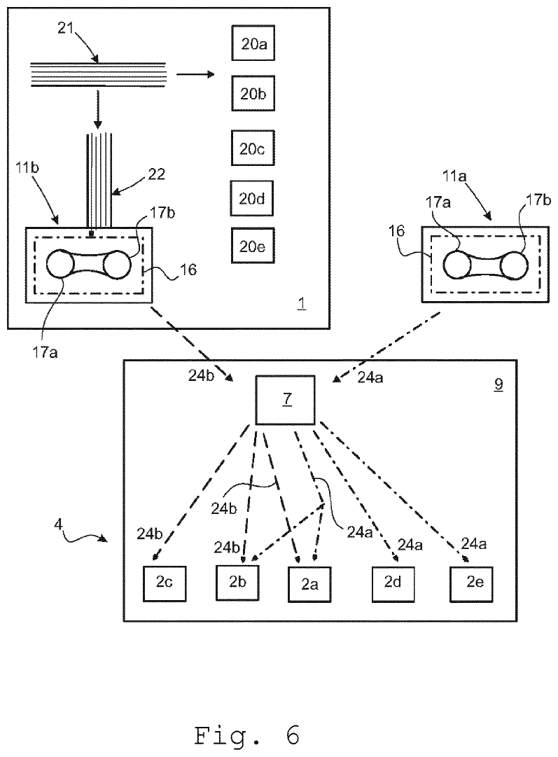

In FIG. 6, a device in accordance with the invention is organised to indicate the progress of a vehicle 1 to the other users of the traffic lanes, by selective activation of preventive lights 2a-2e. Such preventive lights 2a-2e are intended to be visible from the rear of the vehicle 1, by being integrated into a preventive light signalling device 3 represented in FIG. 4 and separately in FIG. 5. To clarify, the rear is identified with respect to the direction of forward progress of a vehicle and/or with respect to an individual whose face is oriented forwards.

In FIG. 4, preventive equipment 4 is provided with a preventive device 3 integrating the preventive lights 2a-2e, represented isolated in FIG. 5. The preventive device 3 comprises a case 6 which is formed by two shells 6a, 6b assembled together, and which houses a radio-frequency receiver 7 and an electrical energy reserve 8. The receiver 7 is formed by a first electronic board 7a, on which diodes 7b are mounted. A rear face of the case 6 is arranged as an optical system for diffusing out of the case 6 the light generated by the diodes 7b, to provide preventive light signalling indicating in particular the presence and/or the progress of the vehicle 1.

The preventive device 3 is installed on a support 9 that the preventive equipment 4 includes. Such preventive equipment 4 may be carried by the driver of the vehicle 1 or be installed at the rear of the vehicle 1. In FIG. 4, for example, the support 9 is arranged as a harness carried in the dorsal position by the driver or a rear passenger of the vehicle 1. Incidentally, a second preventive device 3 may be installed at the front of the harness via means for reversible fastening of the second preventive device 3 on the harness.

More particularly in FIG. 5, the diodes 7b are distributed over the first electronic board 7a so as to form preventive lights 2a-2e signalling the progress of a vehicle 1. A first group 10a of diodes 7b on the left side forms a preventive left indicator light 2b and a second group 10b of diodes 7b on the right side forms a preventive right indicator light 2a. A preventive hazard light 2a, 2b is formed by a simultaneous activation of the preventive right 2a and left 2b indicator lights. A central third group 10c of diodes 7b forms a preventive brake light 2c, a preventive fog light 2e and a preventive position light 2d, by simultaneous activation by packets of diodes 7b of the third group 10c which are respectively assigned thereto by varying the number and/or the light intensity of activation of the diodes 7b.

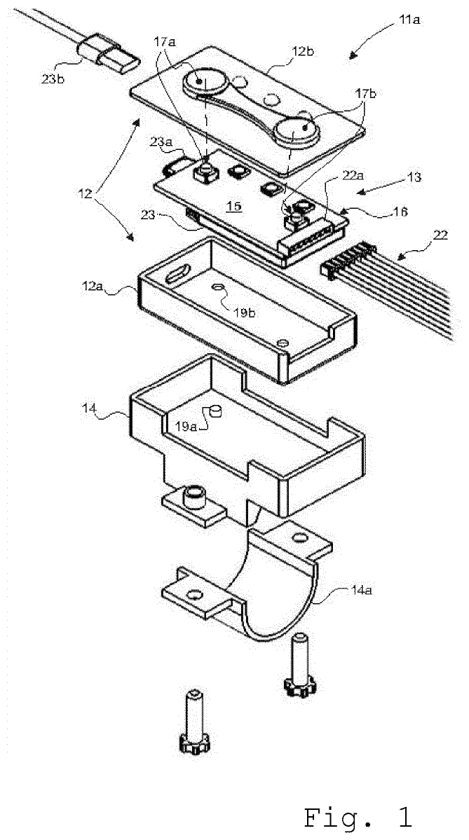

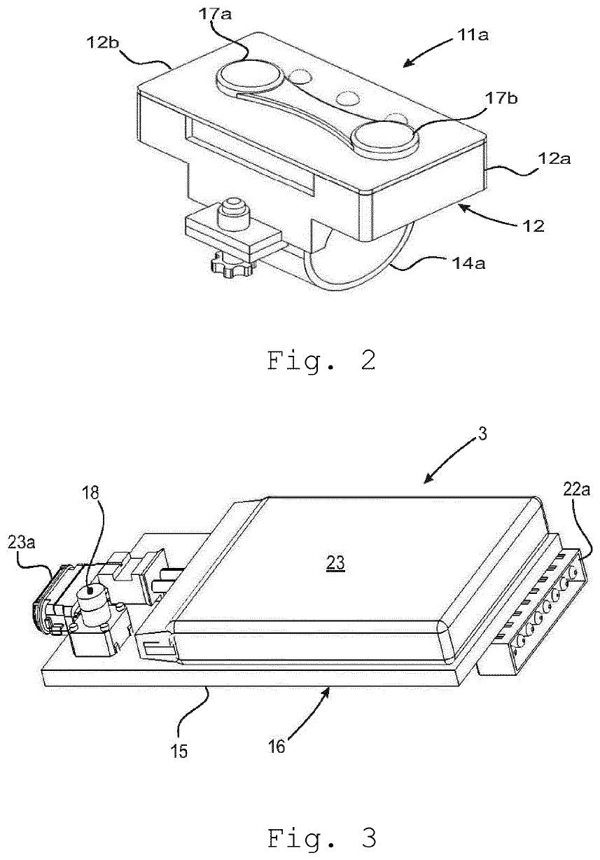

The apparatus comprises two identical control devices 11a, 11b, as illustrated in FIG. 6. In FIGS. 1 to 3, one single control device 11a is represented. The control devices 11a, 11b selectively generate activation commands 24a, 24b for the preventive lights 2a-2e included in the preventive device 3 installed on the support 9.

Each of the control devices 11a, 11b includes a case 12 composed of a bottom 12a and a cover 12b, the case 12 housing an electronic device 13 represented isolated in

FIG. 3. The case 12 itself is housed inside a base 14, via which any one 11a of the control devices 11a, 11b could be installed on a vehicle 1 making the base 14 cooperate with a member 14a for fastening the base 14 on the vehicle 1. In the illustrated example, said fastening member 14a is arranged as a bracket for holding the base 14 by clamping, such as on the handlebar of a cycle.

The control devices 11a, 11b include a second electronic board 15 configured as an emitter 16 of activation commands 24a, 24b for the preventive lights 2a-2e. The second electronic board 15 is equipped with a rechargeable battery 23, at least for supplying the emitter 16 with electrical energy, a first socket 23a for connecting the battery 23 to an electrical cord 23b for charging thereof and a second socket 22a for connecting the emitter 16 to a multi-strand cable 22.

The control devices 11a, 11b are also equipped with control members 17a, 17b, which are arranged as impulse pushbuttons that could be actuated by an individual from the upper face of the cover 12b which is oriented towards the outside of the case 12. The control members 17a, 17b are mounted on the second electronic board 15, their actuation by an individual allowing activating or deactivating the generation and the emission by the emitter 16 of activation commands 24a, 24b.

The control devices 11a, 11b are also equipped with inhibitor members to prohibit the generation by the emitter 16 of at least one of said activation commands 24a, 24b. The inhibitor members could be actuated by an individual, driver and/or passenger in particular, to selectively prohibit the generation of activation commands 24a, 24b by the emitter 16.

This allows using several control devices 11a, 11b which cooperate together to generate each of the respective activation commands 24a, 24b, as illustrated in FIG. 6, the control devices 11a, 11b generating the activation commands 24a, 24b complementarily. According to such complementarity, the activation commands 24a generated by a first control device 11a are different from the activation commands 24b generated by a second control device 11b.

In FIG. 1 and FIG. 3, a first inhibitor member is formed by an inhibitor contactor 18 visible in FIG. 3, which is mounted on the lower face of the second electronic board 15. The inhibitor contactor 18 is monostable and could be actuated by a foolproof 19a, 19b visible in FIG. 1, implementing a push finger 19a formed at the bottom of the base 14 and cooperating with an opening 19b formed through the bottom 12a of the case 12 opposite the inhibitor contactor 18.

Starting from a flip-over of the case 12 following the general extension plane of the second electronic board 15, either the push finger 19a passes through the opening 19b to actuate the inhibitor contactor 18, or the push finger 19a is placed diametrically opposite the opening 19b while being unable to actuate the inhibitor contactor 18, which is then spontaneously held in a stable position. Tus, the inhibitor contactor 18 could be selectively actuated between two distinct installation positions of the case 12 on the base 14.

For example, the inhibition of the generation by the emitter 16 of activation commands 24a, 24b to be prohibited is effective in a stable position of the inhibitor contactor 18, the actuation of the inhibitor contactor 18 causing a stoppage of the prohibition on the emitter 16 to generate any activation commands 24a, 24b to be prohibited. According to one variant and conversely, the inhibition of the generation by the emitter 16 of activation commands 24a, 24b to be prohibited might result from the actuation of the inhibitor contactor 18 from its stable position placing it in station held in an unstable position.

Moreover, one or several control member(s) 17a, 17b are operated to form second inhibitor members, from their actuation by an individual according to a predefined inhibition code. For example, such an inhibition code results from a predefined actuation by an individual of at least one of the control members 17a, 17b, which may vary in number and/or in duration of pulses exerted on said at least one control member 17a, 17b. As a result of the emission of such an inhibition code, the control members 17a, 17b are inefficient in causing the generation(s) by the emitter 16 of activation commands 24a, 24b to be prohibited.

In particular, the inhibitor contactor 18 is assigned to the inhibition of the generation of activation commands 24a, 24b to be prohibited of preventive lights with a short activation period, in particular a preventive right indicator light 2a, a preventive left indicator light 2b and a preventive brake light 2c. The control member(s) 17a, 17b operated as an inhibitor member are assigned to the inhibition of the generation of activation commands 24a, 24b for preventive lights with a long activation period, such as in particular at least one hazard light 2a, 2b, and one fog light 2e and one position light 2d.

In FIG. 6, an example of implementation of an apparatus in accordance with the invention is illustrated, according to which two control devices 11a, 11b are used in complementarity to selectively activate preventive lights 2a-2e that a preventive equipment 4 includes and whose activations are respectively assigned to the control devices 11a, 11b. The apparatus is used for a vehicle 1 which is at least equipped with main lights with a short activation period, typically comprising a main right indicator light 20a, a main left indicator light 20b and a main brake light 20c.

Depending on the type of vehicle 1, the vehicle 1 is still potentially equipped with one or several other main light(s) 20d, 20e, in particular main lights with a long activation period comprising at least one main position light 20d. The main lights 20a-20d of the vehicle 1 are supplied with energy from an electric power supply circuit 21 conventionally equipping the vehicle 1. At least one preventive device 4 is used to reinforce the light signalling of the vehicle 1. The preventive equipment 4 includes a support 9, for example arranged as a harness carried by the driver or a rear passenger, which is provided with preventive lights 2a-2e and with a receiver 7 of activation commands 24a, 24b of the lights preventives 2a-2e.

The preventive lights 2a-2e comprise preventive lights 2a-2c with short activation periods, and preventive lights 2d, 2e, 2a-2b with a long activation period. Typically, lights signalling the progress of a vehicle with a short activation period comprise in particular a brake light 2c, a right indicator light 2a and a left indicator light 2b. Typically again, lights signalling the progress of a vehicle with a long activation period comprise in particular a fog light 2e, a position light 2d and a hazard light 2a-2b by simultaneous activation of the right indicator 2a and left indicator 2b lights.

The operation of a first control device 11a is placed under the control of an individual, in particular the driver or a passenger, to activate preventive lights 2d, 2e, 2a-2b with a long activation period. The first control device 11a may be stored and be accessible when needed, for example by being installed on the vehicle 1 and accessible during a halt of the vehicle 1, or for example by being carried by the individual such as inside a pocket of a garment, for example.

Prior to the use of the first control device 11a, the driver or the passenger places the case 12 on the base 14 in the activation position of the inhibitor contactor 18. The generations by the emitter 16 of the first control device 11a of commands 24a for individual activations of a preventive right indicator light 2a, of a preventive left indicator light 2b, and of a preventive brake light 2c, are then deactivated.

A second control device 11b is installed on the vehicle 1, while being connected to the electric power supply circuit 21 of the main lights 20a-20e, via a multi-strand cable 22 connected to the second control device 11b.

According to the illustrated example, the second control device 11b is preferably supplied with electrical energy from strands of the multi-strand cable 22 which are connected to the wires of the electric power supply circuit 21 assigned to the activation of the main position light 20d of the vehicle 1. The optional supply of electrical energy to the second control device 11b from an electrical circuit on-board the vehicle 1 allows preserving the energy reserve of the battery 23 with which the second control device 11b is equipped. Such a connection causes a cutoff in the electrical connection between the battery 23 and the emitter 16 of the second control device 11b. The operation of the emitter 16 of the second control device 11b is then regulated under the control of the driver of the vehicle 1, from the activation members of the main lights of the vehicle 1 which are conventionally used by the driver.

Prior to the use of the second control device 11b, the driver uses the control members 17a, 17b of the second control device 11b to inhibit the individual activation by the second control device 11b of one or several preventive light(s) 2a-2e of said at least one piece of preventive equipment 4 which are different from the preventive right indicator light 2a, from the preventive left indicator light 2b and from the preventive brake light 2c, such as in particular at least the preventive position light 2d and depending on the type of vehicle the preventive hazard light 2a-2b and the preventive fog light 2e.

When using the device, the functionalities for activating the preventive lights 2a-2e respectively by the control devices 11a, 11b are limited, while being distributed over them. The first control device 11a is used to activate only the preventive lights with a long activation period, in particular the preventive position light 2d, the preventive fog light 2e, and the preventive hazard light 2a-2b by a command 24a for simultaneous activation of the preventive right indicator light 2a and of the preventive left indicator light 2b. The second control device 11b is used to activate only the preventive lights 2a-2c with a short activation period, in particular the preventive brake light 2c, the preventive right indicator light 2a and the preventive left indicator light 2b.

1. A preventive apparatus for activating preventive lights at least during the progress of a vehicle, the apparatus comprising:
preventive light signaling equipment, including a support on which is installed a preventive light signaling device comprising preventive lights, a receiver by radiofrequency of commands for selective activations of the preventive lights, and an electrical energy reserve for supplying at least the receiver with electricity,
identical first and second control devices via which activation commands of the preventive lights are generated, each of the first and second control devices including a respective case housing a respective emitter which generates the activation commands under the control of a driver of the vehicle and which emits by radiofrequency the activation commands generated by the respective emitter,
wherein each of the first and second control devices is equipped with a respective rechargeable battery for supplying the respective emitter with energy, a respective first socket for connecting the battery to an electric power supply source for charging thereof, a respective second socket for connecting the emitter to a circuit for activating main lights equipping a vehicle, and respective control members for selective generation by the respective emitter roof of the activation commands, the respective control members being able to be actuated by an individual,
wherein each of the first and second control devices is equipped with at least one respective inhibitor member which is able to be actuated by an individual to inhibit generation by the emitter of at least one of activation commands which is to be prohibited, and
wherein each of the first and second control devices generates the activation commands complementarily.

2. The apparatus according to claim 1, wherein the at least one inhibitor member is formed by at least one inhibitor contactor, which is dedicated to inhibition of a generation by the emitter of at least one activation command to be prohibited.

3. The apparatus according to claim 2, wherein the inhibitor contactor is monostable and is able to selectively actuated by a foolproof between two distinct positions of installation of the case on a base for mounting the control device on the vehicle.

4. The apparatus according to claim 3, wherein the inhibition of the generation by the emitter of the at least one of the activation commands to be prohibited is spontaneously effective in a stable position of the inhibitor contactor, and conversely, the generation by the emitter of the at least one of the activation commands to be prohibited is effective by actuation of the inhibitor contactor by the foolproof.

5. The apparatus according to claim 1, wherein the at least one inhibitor member is formed by at least one of the control members.

6. The apparatus according to claim 1, wherein the at least one inhibitor member is a member for inhibiting a generation of activation commands of preventive lights with a long activation period, the preventive lights with a long activation period at least comprising a preventive hazard light, a preventive fog light and a preventive position light.

7. The apparatus according to claim 1, wherein the at least one inhibitor member is a member for inhibiting a generation of activation commands of preventive lights with a short activation period, the preventive lights with a short activation period at least comprising a preventive right indicator light, a preventive left indicator light and a preventive brake light.

8. The apparatus according to claim 1, comprising a first support arranged as a harness for carrying the preventive light signaling equipment in a dorsal position of an individual.

9. The apparatus according to claim 1, comprising a second support is a translucent box which houses the preventive lights visible from at least one external face of the box and which is provided with members for reversibly fastening the preventive light signaling equipment in a rear position on the vehicle.

10. The apparatus according to claim 1, wherein the lights of at the preventive light signaling equipment of the apparatus comprise:
a preventive right indicator light and a preventive left indicator light,
a preventive brake light,
a preventive hazard light,
a preventive position light, and
a preventive fog light.

11. A method for implementing the apparatus according to claim 1 with a vehicle equipped the main lights, the method comprising:
activating the preventive lights of the preventive light signaling equipment, by at least one of the first and second control devices, and
using the first and second control devices in complementarity starting from an activation or a deactivation of the at least one inhibitor member which the control devices respectively include, by distribution between the control devices of the activation commands which the control devices respectively emit for the activation of the preventive lights of the preventive light signaling equipment.

12. The method according to claim 11, wherein the first and second control devices are used in complementarity, wherein:
in the first control device, the control members are able to be actuated by the driver of the vehicle, a generation by the emitter of commands for individual activations of a preventive right indicator light, of a preventive left indicator light, and of a preventive brake light being deactivated via the at least one inhibitor member of the first control device, and
in the second control device installed on the vehicle the emitter is connected via the second socket to a multi-strand cable for plugging the emitter to an electric power supply circuit equipping the vehicle and assigned to selective activation of main lights of the vehicle, the emitter of the second control device generating commands for individual activation of preventive lights comprising a preventive right indicator light, a preventive left indicator light a preventive brake light, a generation by the second emitter of activation commands of any other preventive lights of the preventive light signaling equipment being deactivated via the at least one inhibitor member of the second control device.

13. The method according to claim 12, wherein the emitter of the second control device is supplied with electrical energy from strands of the multi-strand cable, the strands being connected to wires of the electric power supply circuit assigned to activation of a main position light of the vehicle, an electrical connection between the emitter and the rechargeable battery then being deactivated.

14. The method according to claim 12, wherein, in each of the first and second control devices, the at least one inhibitor member is formed by at least one inhibitor contactor, which is dedicated to the inhibition of a generation by the emitter a one activation command to be prohibited, and the at east one inhibitor member is formed by at least one of the control members, the method comprising:
deactivating generations by the emitter of the first control device of commands for individual activation of a preventive right indicator light, of a preventive left indicator light and of a preventive brake light, via the inhibitor contactor, and
deactivating generations by the emitter of the second control device of activation commands of any preventive lights other than the preventive right indicator light, the preventive left indicator light and the preventive brake light via the control members equipping the second control device.

15. The method according to claim 13, wherein, in each of the first and second control devices, the at least one inhibitor member is formed by at least one inhibitor contactor, which is dedicated to the inhibition of a generation by the emitter of at least one activation command to be prohibited, and the at least one inhibitor member is formed by at least one of the control members, the method comprising:
deactivating generations by the emitter of the first control device of commands for individual activation of a preventive right indicator light, of a preventive left indicator light and of a preventive brake light, via the inhibitor contactor, and
deactivating generations by the emitter of the second control device of activation commands of any preventive lights other than the preventive right indicator light, the preventive left indicator light and the preventive brake light via the control members equipping the second control device.

16. The apparatus according to claim 2, wherein the at least one inhibitor member is formed by at least one of the control members.

17. The apparatus according to claim 3, wherein the at least one inhibitor member is formed by at least one of the control members.

18. The apparatus according to claim 4, wherein the at least one inhibitor member is formed by at least one of the control members.

19. The apparatus according to claim 2, wherein the at least one inhibitor member) is a member for inhibiting a generation of activation commands of preventive lights with a long activation period, the preventive lights with a long activation period at least comprising a preventive hazard light, a preventive fog light and a preventive position light.

20. The apparatus according to claim 2, wherein the at least one inhibitor member is a member for inhibiting a generation of activation commands of preventive lights with a short activation period, the preventive lights with a short activation period at least comprising a preventive right indicator light, a preventive left indicator light and a preventive brake light.
